(19) United States
(12) Patent Application Publication
(10) Pub. No.: US 2006/0000128 A1
(43) Pub. Date: Jan. 5, 2006

(54) LED sign with continuous illumination effect

(76) Inventor: Frank Pan, Rosemead, CA (US)

Correspondence Address: RAYMOND Y. CHAN, 108 N. YNEZ AVE., SUITE 128, MONTEREY PARK, CA, 91754, US

(21) Appl. No.: 10/884,583

(22) Filed: Jul. 2, 2004

(51) Int. Cl. G09F 13/22; G09F 9/00

(52) U.S. Cl. 40/544

(57) ABSTRACT

A LED sign includes a figure sign, a light guider and a plurality of LED illuminators. The light guider is shaped corresponding to the figure sign, and has an illumination channel. The LED illuminators are spacedly disposed within the illumination channel of the light guider for generating lights towards the illumination channel in such a manner that the lights are accumulated within the illumination channel to form a continuous illumination effect along the illumination channel.

### BACKGROUND OF THE PRESENT INVENTION

1. Field of Invention

The present invention relates to a LED (Light Emitting Diode) sign, and more particularly to a LED sign with continuous illumination effect which is capable of forming a line of light source from a plurality of LED illuminators for highlighting particular characters, such as an advertisement sign.

2. Description of Related Arts

Illuminating devices are widely utilized to perform differing commercial or business tasks. For example, advertisements are highlighted by light boxes so that during night time people can be notified and attracted by sharp and colorful advertisements. Besides, neon signs are usually set up in front of shops showing the opening status of them.

There exist a handful of illuminating devices in the marketplace, the two most popular being neon lights and advertisement light boxes in that they are conveniently available in regular business equipment suppliers and that they can sustain prolonged usage without getting out of order frequently. However, these cannot be taken to mean that they are free from disadvantages. In fact, some people are actually forced to tolerate those disadvantages and continue using them simply because they cannot find suitable alternatives.

A major disadvantage of conventional light boxes and neon lights is that they generate a large amount of heat while operating. Not to mention safety problem resulting from such heat, this large amount of heat itself represents a serious waste of large amount of energy which in turns reflects in unnecessary yet inevitable rise of the user's operating cost. Thus it comes to a lose-lose situation that the user pays higher for more serious loss of natural resources (electricity) without gaining any extra economic profit.

Another disadvantage is that conventional neon light or fluorescent light box is extremely fragile to physical impact. Thus, one has to put extra care in transporting the neon lights or the light boxes in order to prevent accidental damage on the part of them. This not only increases the cost of handling such products, but also present a potential risk to those handling or purchasing the products.

As a matter of fact, engineers are eager to seek alternatives for those conventional neon lights and advertisement light boxes. For example, they have thought of using LEDs for generating light to replace conventional neon lights and fluorescent lamps. However, there exist some inherent disadvantages for using LEDs. For example, despite the fact that LED is more long-lasting and economically more efficient, light from each particular LED is not generally strong enough for highlighting an advertisement or business signs. As a result, there exist some LED light boxes which comprise a plurality of LEDs electrically connected with each other to generate sufficient amount of illumination as a whole. However, as each LED represents a single point source of light, each light box eventually comes up with a plurality of discrete light sources and the overall illumination effect is far from satisfactory. Thus, the problem of how to convert what is originally discrete single points of light source to a continuous line of light source is a pressing problem for engineers.

### SUMMARY OF THE PRESENT INVENTION

A main object of the present invention is to provide a LED sign which is capable of forming a uniform line of light source from a plurality of LED illuminators for highlighting a particular character, such as an advertisement sign.

Another object of the present invention is to provide a LED sign comprising at least one light guider for forming an illumination channel which accumulates light from a plurality of LED illuminators to form a continuous illumination effect for highlighting a predetermined character, such as a particular advertisement sign.

Another object of the present invention is to provide a LED sign comprising at least a figure sign of a predetermined color and aesthetic pattern so that it may either be highlighted by the LED illuminators to form the continuous illumination effect, or, where the LED illuminators are not lit up, arranged to display a particular character by virtue of its own color and aesthetic pattern without the lighting from the LED illuminators. In other words, the particular figure sign, such as the advertisement, may be used anytime with or without the LED illuminators lighting.

Another object of the present invention is to provide a LED sign which is simple in structure yet capable of delivering a continuous illumination light effect. In other words, the manufacturing cost and the ultimate selling price of the present invention must be minimized.

Another object of the present invention is to provide a LED sign which is durable, effective, efficient, and economical during operation.

Accordingly, in order to accomplish the above objects, the present invention provides a LED sign, comprising:
a figure sign shaped to form at least a character;
at least a light guider, which is shaped corresponding to the figure sign, having a plurality of light cavities and an illumination channel communicating with the light cavities, wherein the figure sign is supported by the light guider to optically communicate with the illumination channel; and
a plurality of LED illuminators spacedly disposed within the light cavity of the light guider for generating lights towards the illumination channel in such a manner that the lights are accumulated within the illumination channel to form a continuous illumination effect so as to project towards and to highlight the figure sign.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of a LED sign according to a preferred embodiment of the present invention.

FIG. 1B illustrates an alternative mode of the LED sign according to the above preferred embodiment of the present invention.

FIG. 2A is a schematic sectional side view of the LED sign according to the above preferred embodiment of the present invention.

FIG. 2B illustrates another alternative mode of the LED sign according to the above preferred embodiment of the present invention.

FIGS. 3A and 3B illustrate the first alternative mode of the LED sign according to the above preferred embodiment of the present invention.

FIG. 4 is a second alternative mode of the LED sign according to the above preferred embodiment of the present invention.

FIGS. 5A and 5B illustrate third alternative mode of the LED sign according to the above preferred embodiment of the present invention.

### DETAILED DESCRIPTION OF THE PREFERRED EMBODIMENT

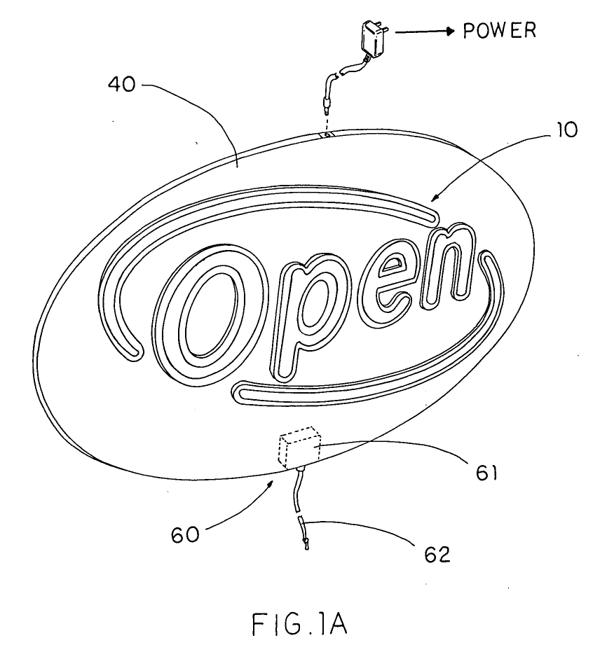

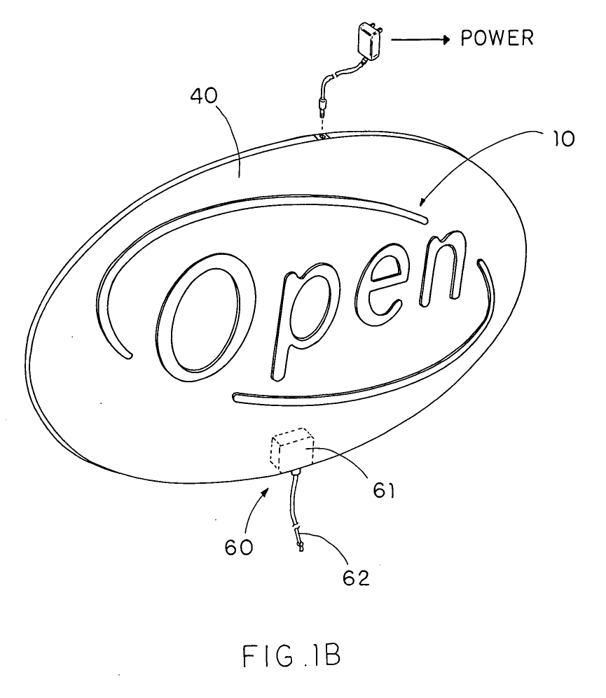

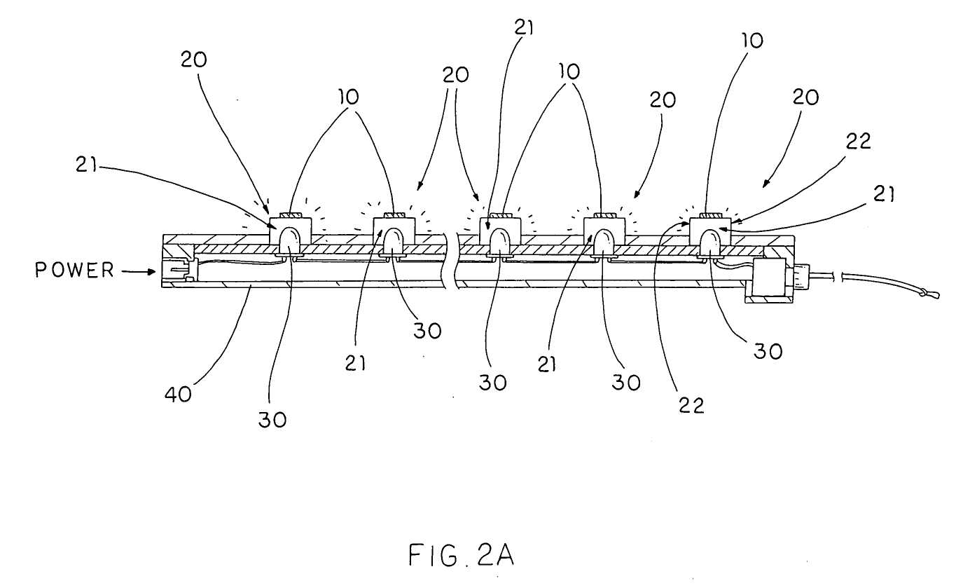

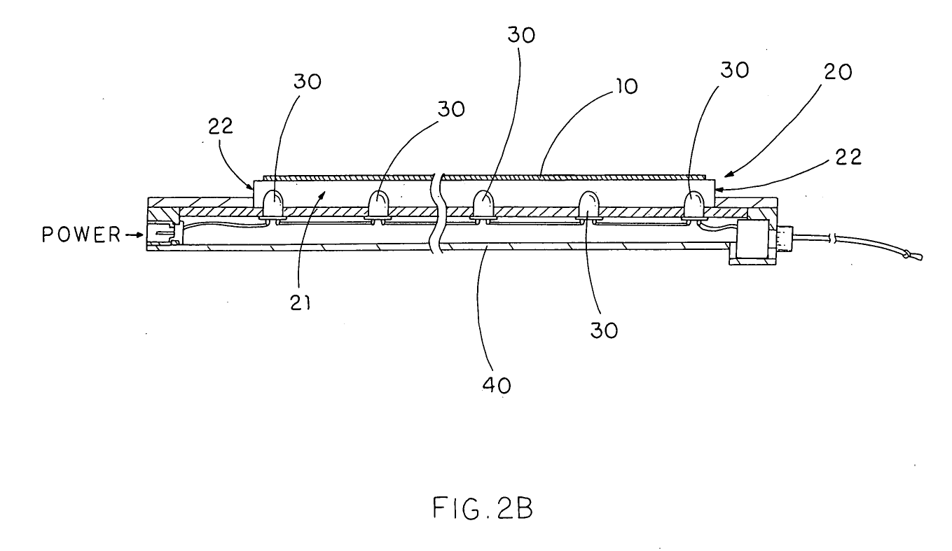

Referring to FIG. 1A, FIG. 1B and FIG. 2A, FIG. 2B of the drawings, a LED sign according to a preferred embodiment of the present invention is illustrated, in which the LED sign comprises a figure sign 10, at least one light guider 20, and a plurality of LED illuminators 30.

The figure sign 10 is shaped as forming a particular character having a predetermined light transmisivity and color. For example, the figure sign 10 may be embodied as a ‘O’ character in which it may be coated with a particular color for particular purpose, such as for use in a particular advertisement campaign.

The light guider 20 is shaped corresponding to the character sign 10, wherein it is overlappedly supported on a central portion of a front side of the light guider 20 and optically communicated with the illumination channel 21. Moreover, the light guider 20 further has a plurality of light cavities 23 for receiving the LED illuminators 30.

The plurality of LED illuminators 30 are spacedly disposed within the light cavity 23 of the light guider 20 for generating lights towards the illumination channel 21 in such a manner that the lights so generated are accumulated within the illumination channel 21 so as to form a continuous illumination effect and projected towards the figure sign 10 for highlighting that particular character, such as the character ‘S’.

The light guider 20 comprises an elongated solid member made of translucent materials to form the illumination channel 21 in a solid manner such that when the LED illuminators 30 project the light towards the illumination channel 21, the light are evenly diffused along the illumination channel 21 to form the continuous illumination effect.

Therefore, the illumination channel 21 is a physical passageway which has a predetermined light transmisivity so as to allow light passing therethrough. Referring to FIG. 2 of the drawings, the illumination cavities 23 are indently formed along a rear side of the light guider 20 to receive the LED illuminators 30 respectively, in such a manner that a head portion of each of the LED illuminators 30 is embedded on the rear side of the light guider 20 towards the figure sign 10.

Each of the LED illuminators 30 is adapted to radiate light at an angle of approximately 120° frontwardly from a head portion of that LED illuminator 30. According to the preferred embodiment, the head portion is arranged to directly face the illumination channel 21 such that a maximum intensity of light is propagated to the illumination channel 21 for forming the single line of light source to highlight the figure sign 10.

The LED sign further comprises a supporting frame 40 having a displaying side that the light guider 20 is protruded therefrom to substantially support the light guider 20 in position, wherein the LED illuminators 30 are spacedly supported on the supporting frame 40 along the illumination channel 23 of the light guider 20.

Each of the LED illuminators 30 are electrically connected with each other in the supporting frame 40 which is then electrically connected to a power source for lighting up the LED illuminators 30 through a power inlet provided on the supporting frame 40.

The supporting frame 40 may be longitudinally extended to form an elongated structure wherein a plurality of light guiders 20 and figure signs 10 are protruded therefrom so as to form a large-scale advertising sign. For example, the advertising sign may be ‘OPEN’ or the likes, as shown in FIG. 1 of the drawings.

Thus, the LED sign further comprises a control switch 60 provided on the supporting frame and electrically connected with the LED illuminators 30 for controlling an operation of the LED illuminators 30. According to the preferred embodiment, the control switch 60 comprises a control box 61 mounted on a bottom portion of the supporting frame 40, and an actuation string 62 operatively extended from the control box 61 in such a manner that it is capable of being pulled to alternatively turn on an off the LED illuminators 30. In other words, a user is able selectively turn on or off the LED sign by slightly pulling the actuation sting 62.

From the foregoing descriptions, it can be shown that when the LED illuminators 30 are connected to a power source, such as the external AC power source or a DC power source, they would be lit up and generate light in the illumination cavity 23 towards the illumination channel 21. The light in the illumination channel 21 would then accumulate and form a line of light source projecting towards the figure sign 10. The light would then pass through the illumination channel 21 to reach an outside of the light guider 20 through a front side edge portion thereof in such a manner as to highlight the figure sign 10. The figure sign 10 may also be made to be light transmissible but having a light transmisivity different from that of the illumination channel 21, in such a case, difference in the transmisivity would produce special light effect to the LED sign of the present invention. Ultimately, it is worth mentioning that the discrete LED illuminators 30 are arranged to generate a single line of light source for highlighting the figure sign 10.

Accordingly, the figure sign 10 should be made of opaque material, and shaped and sized smaller than that of the light guider 20, wherein when the LED illuminators are switched off, the figure sign 10 physically forms a display sign in a solid font manner, and when the LED illuminators 30 are switched on, the light within the illumination channel 21 forms the continuous illumination effect to encircle a surrounding edge of the figure sign 10 in a shaded font manner.

Furthermore, the figure sign 10 can be furnished with a particular pattern of light effect or aesthetical design such that even when the LED illuminators 30 are not in use, the figure sign 10 by itself would also present a complete visible sign, though without illumination.

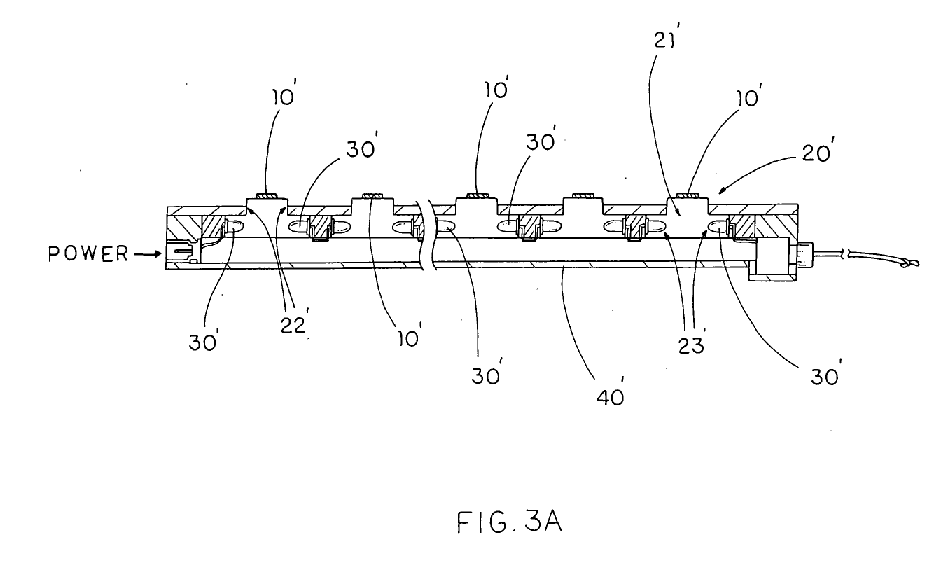

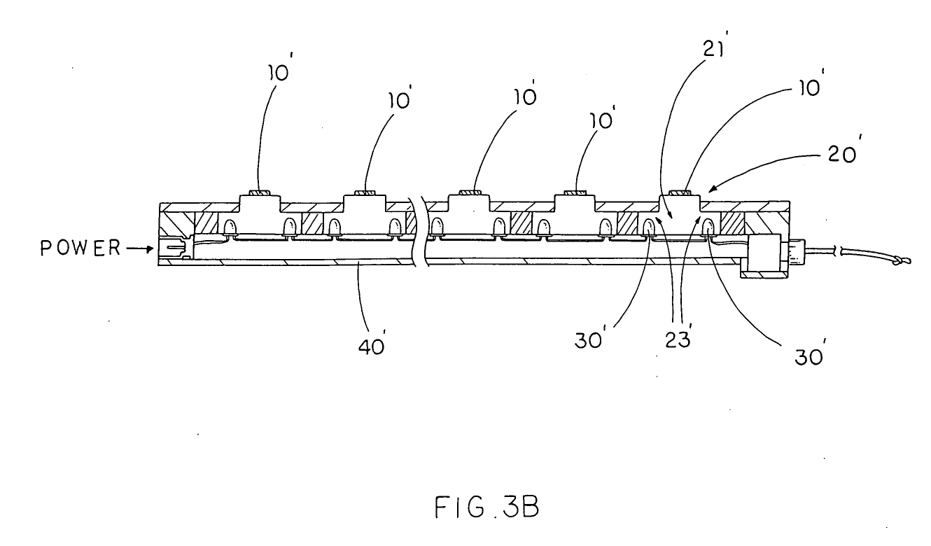

Referring to FIG. 3A of the drawings, an alternative mode of the LED sign according to the preferred embodiment of the present invention is illustrated. According to the alternative mode, the light guider 20′ has two sidewalls 22′ forming two illumination cavities 23′ along two sides of the illumination channel 21′ respectively wherein the LED illuminators 30′ are spacedly disposed in the illumination cavities 23′ for generating light towards the illumination channel 21′. The light from the LED illuminators 30′ are internally reflected and accumulated within the illumination channel 21′ to form a continuous light effect projecting towards the figure sign 10′. Since the figure sign 10′ has a predetermined light transmisivity, the continuous light effect forms a single line of light source to highlight the figure sign 10′ in a continuous illuminating manner.

In order to enhance the light accumulation performance, the light guider 20′ further comprises two light reflecting layers provided on a rear wall of the illumination channel 21′ for intensifying internal light reflections therewithin. The light reflecting layer is preferably embodied as a silver layer coated on the rear wall of the light cavities 23′ respectively, wherein light from the LED illuminators 30′ would impinge upon the light reflecting layer and results in intense multiple reflections within the illumination channel 21′ to form the line of light source. Obviously, other kind of light reflectors layers, such as mirrors, which can also cause this reflection pattern within the illumination channel 21′, may be utilized as alternatives.

As a slight alternative of the first alternative mode, as shown in FIG. 3B of the drawings, the respective head portion of each of the LED illuminators 30′ may be mounted to face towards the front in the respective illumination cavity 23′, i.e. towards the figure sign 10′.

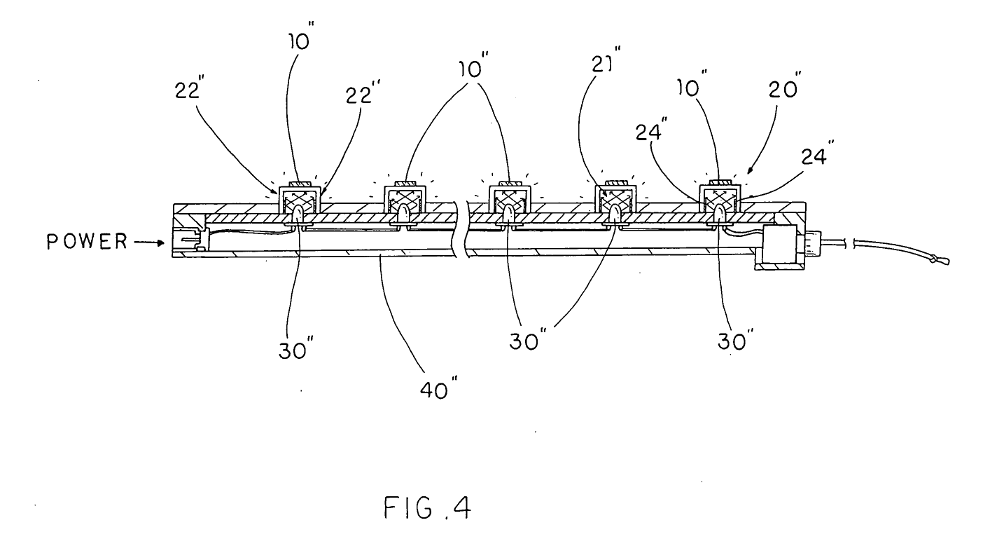

FIG. 4 illustrates a second alternative mode of the LED sign according to the above preferred embodiment of the present invention, in which case the light guider 20″ comprises an elongated hollow member made of translucent material to define the illumination channel 21″ therewithin and the light cavities along two sidewalls of the illumination channel respectively, such that when the LED illuminators project the lights towards the illumination channel, the light are evenly diffused along the illumination channel to form the continuous illumination effect.

In order to further enhance internal reflections inside the illumination channel 21″, the light guider 20″ further comprises two side reflectors 24″ provided on two sidewalls 22″ thereof in the light cavities 23″ respectively so as to substantially reflect those portions of light impinging on the sidewall 22″ back to the illumination channel 21″. As such, the line of light source forming in the illumination channel 21″ will be of improved coherence.

The two side reflectors 24′ are preferably embodied as two reflective mirrors or silver coatings from which the light can be substantially reflected back to the illumination channel 21′.

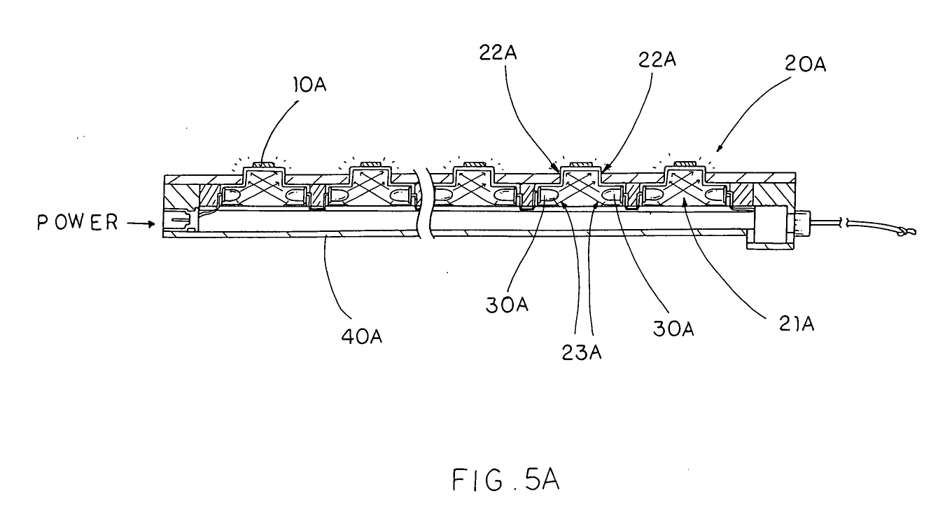

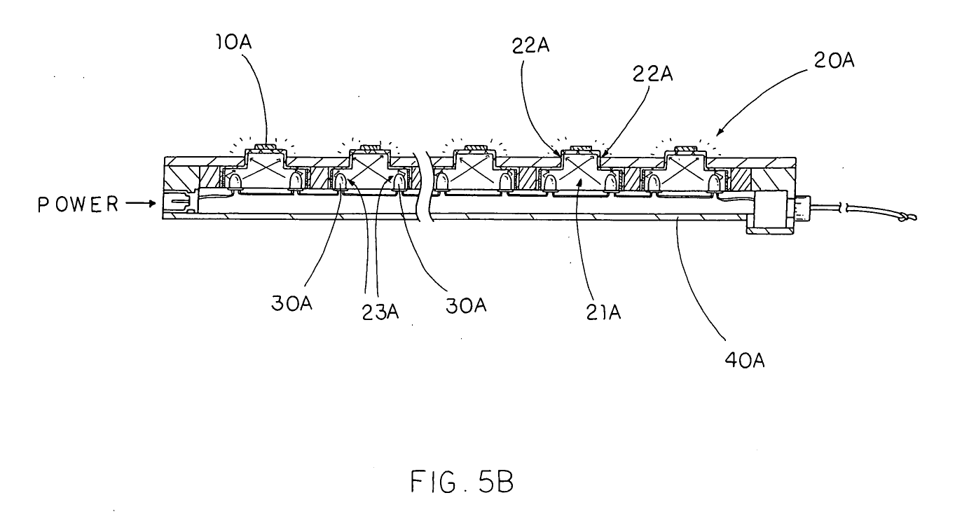

Referring to FIG. 5A of the drawings, a third alternative of the LED sign according to the above preferred embodiment of the present invention is illustrated, in which the light guider 20A has a hollow member which communicates with the light cavity 23A. The figure sign 10A is made of opaque material, and shaped and sized smaller than that of the light guider 20A, wherein when the LED illuminators 30A are switched off, the figure sign 10A physically forms a display sign in a solid manner, and when the LED illuminators 30A are switched on, the light within the illumination channel 21A forms the continuous illumination effect to encircle a surrounding edge of the figure sign 10A in a shaded font manner.

Moreover, the two sidewalls 22A of the light guider 20A form two illumination cavities 23A along two sides of the illumination channel 21A respectively wherein the LED illuminators 30A are spacedly disposed in the illumination cavities 23A for generating light towards the illumination channel 21A. Then, the light from the LED illuminators 30A are internally reflected and accumulated within the illumination channel 21A to form a continuous light effect projecting towards the figure sign 10A. Since the figure sign 10A has a predetermined light transmisivity, the continuous light effect forms a single line of light source to highlight the figure sign 10A in a continuous illuminating manner.

As shown in FIG. 5B if the drawings, it is worth mentioning that each of the LED illuminators 30A may be embodied as radiating light sidewardly from the head portion of that LED illuminator 30A at an angle of approximately 120° so that although the LED illuminator 30A is facing towards the figure sign 10A in the respective illumination cavity 23A, the light radiating therefrom would propagate sidewardly towards the respective sidewall 22A and the illumination channel 21A.

In order to further enhance internal reflections inside the illumination channel 21A, the light guider 20A further comprises two side reflectors 24A provided on two sidewalls 22A thereof in the light cavities 23A respectively so as to substantially reflect that portion of light impinging on the sidewall 22A back to the illumination channel 21A. As such, the line of light source forming in the illumination channel 21A will be of improved coherence.

The two side reflectors 24A are preferably embodied as two reflective mirrors or silver coatings from which the light can be substantially reflected back to the illumination channel 21A.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-20. (canceled)

21. A LED sign, comprising:
at least a light guider having a plurality of light cavities and an illumination channel communicating with said light cavities; and
a plurality of LED illuminators disposed within said light cavities of said light guider respectively for generating lights towards said illumination channel in such a manner that said lights are accumulated within said illumination channel to form a continuous illumination effect so as to highlight said light guider.

22. The LED sign, as recited in claim 21, wherein said light guider comprises an elongated solid member to form said illumination channel in a solid manner, wherein said light cavities are spacedly and alignedly formed along said solid member to receive said LED illuminators respectively such that when said LED illuminators project said lights towards said illumination channel, said lights are evenly diffused along said illumination channel to form said continuous illumination effect.

23. The LED sign, as recited in claim 22, further comprising a figure sign, which is shaped and sized smaller than said light guider, provided on said light guider to alignedly cover said LED illuminators such that when said LED illuminators are switched on, said lights within said illumination channel forms said continuous illumination effect towards said figure sign.

24. The LED sign, as recited in claim 23, wherein said figure sign is made of opaque material such that when said LED illuminators are switched on, said lights within said illumination channel forms said continuous illumination effect to encircle a surrounding edge of said figure sign.

25. The LED sign, as recited in claim 22, further comprising a supporting frame having a displaying side that said light guider is protruded therefrom to substantially support said light guider in position, wherein said LED illuminators are spacedly supported on said supporting frame along said illumination channel of said light guider.

26. The LED sign, as recited in claim 23, further comprising a supporting frame having a displaying side that said light guider is protruded therefrom to substantially support said light guider in position, wherein said LED illuminators are spacedly supported on said supporting frame along said illumination channel of said light guider.

27. The LED sign, as recited in claim 24, further comprising a supporting frame having a displaying side that said light guider is protruded therefrom to substantially support said light guider in position, wherein said LED illuminators are spacedly supported on said supporting frame along said illumination channel of said light guider.

28. The LED sign, as recited in claim 21, wherein said light guider comprises an elongated solid member to define said illumination channel in a solid manner and said light cavities spacedly along two side edges of said solid member respectively, such that when said LED illuminators project said lights towards said illumination channel, said lights are evenly diffused along said illumination channel to form said continuous illumination effect.

29. The LED sign, as recited in claim 28, wherein said light guider is made of translucent material adapted to diffuse said lights from said LED illuminators projecting along said illumination channel to form said continuous illumination effect.

30. The LED sign, as recited in claim 28, further comprising a supporting frame having a displaying side that said light guider is protruded therefrom to substantially support said light guider in position, wherein said LED illuminators are spacedly supported on said supporting frame along said illumination channel of said light guider.

31. The LED sign, as recited in claim 29, further comprising a supporting frame having a displaying side that said light guider is protruded therefrom to substantially support said light guider in position, wherein said LED illuminators are spacedly supported on said supporting frame along said illumination channel of said light guider.

32. The LED sign, as recited in claim 21, wherein said light guider comprises an elongated hollow member to define said illumination channel therewithin and said light cavities spacedly along two sidewalls of said illumination channel respectively, such that when said LED illuminators project said lights towards said illumination channel, said lights are evenly diffused along said illumination channel to form said continuous illumination effect.

33. The LED sign, as recited in claim 32, wherein said light guider is made of translucent material adapted to diffuse said lights from said LED illuminators projecting along said illumination channel to form said continuous illumination effect.

34. The LED sign, as recited in claim 32, wherein said light guider further comprises two light reflectors provided at two outer walls of light cavities respectively, wherein a head portion of each of said LED illuminators is transversely positioned within said respective light cavity such that said light reflectors reflect said lights from said LED illuminators towards said illumination channel to highlight said light guider.

35. The LED sign, as recited in claim 33, wherein said light guider further comprises two light reflectors provided at two outer walls of light cavities respectively, wherein a head portion of each of said LED illuminators is transversely positioned within said respective light cavity such that said light reflectors reflect said lights from said LED illuminators towards said illumination channel to highlight said light guider.

36. The LED sign, as recited in claim 32, wherein said light guider further comprises two light reflectors provided at bottom walls of light cavities respectively, wherein a head portion of each of said LED illuminators is longitudinally positioned within said respective light cavity such that said light reflector reflect said lights from said LED illuminators towards said illumination channel to highlight said light guider.

37. The LED sign, as recited in claim 33, wherein said light guider further comprises two light reflectors provided at bottom walls of light cavities respectively, wherein a head portion of each of said LED illuminators is longitudinally positioned within said respective light cavity such that said light reflector reflect said lights from said LED illuminators towards said illumination channel to highlight said light guider.

38. The LED sign, as recited in claim 35, further comprising a supporting frame having a displaying side that said light guider is protruded therefrom to substantially support said light guider in position, wherein said LED illuminators are spacedly supported on said supporting frame along said illumination channel of said light guider.

39. The LED sign, as recited in claim 37, further comprising a supporting frame having a displaying side that said light guider is protruded therefrom to substantially support said light guider in position, wherein said LED illuminators are spacedly supported on said supporting frame along said illumination channel of said light guider.
